(19) United States
(12) Patent Application Publication
(10) Pub. No.: US 2011/0212803 A1
(43) Pub. Date: Sep. 1, 2011

(54) DRIVE FOR A VEHICLE, AND METHOD FOR PROPELLING A VEHICLE

(75) Inventor: THIEU MAAS, NZ Weert (NL)

(73) Assignee: Benteler Automobiltechnik GmbH, Paderborn (DE)

(21) Appl. No.: 12/855,103

(22) Filed: Aug. 12, 2010

(30) Foreign Application Priority Data
Aug. 12, 2009 (DE) 10 2009 036 992.9

(51) Int. Cl. F16H 48/06; F16H 1/28

(52) U.S. Cl. 475/150; 475/149

(57) ABSTRACT

A drive for a vehicle includes a first electric motor, a second electric motor, and a planetary gear train to couple the first and second electric motors. The planetary gear train has a sun wheel mounted on a drive shaft, and a ring gear mounted on a drive shaft. The drive shaft of the sun wheel is hereby coupled with the first electric motor, and the drive shaft of the ring gear is coupled with the second electric motor. An axle drive unit is operably connected with wheels of the vehicle and coupled with planet wheels of the planetary gear train. Sun wheel and ring gear are rotatable in opposite directions in a startup phase. As a result, the electric motors are operated in a characteristic mapping range with higher torque before the start, thereby positively affecting the acceleration of the chassis when changing the relative rotation speed.

### CROSS-REFERENCES TO RELATED APPLICATIONS

This application claims the priority of German Patent Application Serial No. 10 2009 036 992.9, filed Aug. 12, 2009, pursuant to 35 U.S.C. 119(a)-(d), the content of which is incorporated herein by reference in its entirety as if fully set forth herein.

### BACKGROUND OF THE INVENTION

The present invention relates, in general, to a drive for a vehicle, and to a method for propelling a vehicle.

The following discussion of related art is provided to assist the reader in understanding the advantages of the invention, and is not to be construed as an admission that this related art is prior art to this invention.

U.S. Pat. No. 7,384,357 describes an electric motor drive unit for use in hybrid electric motor vehicles in addition to an internal combustion engine. The electric drive unit includes an electric motor, two drive shafts, a first speed reduction planetary gearset driven by the motor, a second speed reduction gearset driven by an output of the first gearset, and a compound planetary differential gearset including an input driveably connected to the output of the second gearset, a first differential output driveably connected to the first drive shaft, and a second differential output driveably connected to the second drive shaft.

In addition to hybrid vehicles, electric vehicles are known that operate solely on electric energy. In electric vehicles, acceleration, especially when heavy vehicles are involved, becomes problematic however, in particular on uneven terrain because electric motors generate only a relative low torque for propelling the wheels during starting or acceleration from standstill of the vehicle. One approach to address this problem involves the installation of large electric motors to generate the required torque from the beginning. This, however, requires added installation space in the vehicle. Another approach to address this acceleration problem proposes the provision of a clutch in combination with a multi-speed manual transmission. This clutch provides that the electric motor is operated prior to acceleration of the vehicle already in a beneficial characteristic mapping range. After clutch engagement, the vehicle can accelerate from standstill with adequate torque. This approach has shortcomings because clutches wear off over time.

It would therefore be desirable and advantageous to provide an improved drive for an electric vehicle to obviate prior art shortcomings and to deliver a higher torque during acceleration from standstill without the need for a clutch.

### SUMMARY OF THE INVENTION

According to one aspect of the present invention, a drive for a vehicle includes a first electric motor, a second electric motor, a planetary gear train coupling the first and second electric motors, with the planetary gear train including a sun wheel mounted on a drive shaft, and a ring gear mounted on a drive shaft, and an axle drive unit operably connected with wheels of the vehicle and coupled with planet wheels of the planetary gear train, wherein the drive shaft of the sun wheel is coupled with the first electric motor, and the drive shaft of the ring gear is coupled with the second electric motor, and wherein the sun wheel and the ring gear are rotatable in opposite directions in a startup phase without propulsion of the wheels of the vehicle.

The present invention resolves prior art problems by providing a drive which is so configured that the drive shafts for the sun wheel and the ring gear can be operated in such a way in dependence of the rotation direction of the electric motors that the planet wheels of the planetary gear train or a planet carrier do not transmit a rotational movement onto the axle drive unit. To prevent the planet carrier from transmitting a rotational movement onto the axle drive unit and thus onto the wheels of the vehicle, the rotation speeds of the drive shaft of the sun wheel and the drive shaft of the ring gear are adjusted to one another during a revving-up phase.

When certain motor speeds have been reached, with both electric motors developing a sufficient torque, an acceleration phase from standstill can be initiated. The rotation speed of one of the electric motors is then decreased or even reduced to zero. As a result, the planet wheels begin to orbit around the sun wheel. The rotation resulting from the rolling motion of the planet wheels is transmitted via the planet carrier onto the axle drive unit. The energy that is hereby created is sufficient to accelerate even heavier vehicles from standstill on uneven road surfaces.

According to another advantageous feature of the present invention, the axle drive unit can include a differential gear, wherein the differential gear can be configured also as electronically controlled differential gear.

In order to be able to effectively drive the vehicles also at increasing speed, the second electric motor is activated to complement the first electric motor after acceleration from standstill. The second electric motor drives the drive shaft of the ring gear in the same rotation direction as the one of the drive shaft of the sun wheel.

According to another aspect of the present invention, a method of propelling a vehicle includes the step of operating a drive shaft of a first electric motor and a drive shaft of a second electric motor in a startup phase of the vehicle such that a planet carrier of a planetary gear train is at a standstill so that there is no transmission of a driving force in the startup phase on a wheel axle coupled with the drive shafts via an axle drive unit.

The drive shafts of the first and second electric motors are driven in the startup phase in opposite directions, with the drive shaft driven by the first electric motor driving a sun wheel and the drive shaft driven by the second electric motor driving a ring gear of the planetary gear train such that the planet carrier of the planetary gear train stands still so that the wheel axle, which is coupled via the axle drive unit with the drive shafts, is not acted upon by a driving force in the startup phase. The planet wheels do not orbit around the sun wheel.

The startup phase is continued by an acceleration phase during which the second electric motor does not drive the drive shaft of the ring gear, and the drive shaft of the sun wheel is solely driven by the first electric motor. The planet wheels now orbit around the sun wheel and drive the planet carrier. When higher speeds are involved, the drive shaft of the ring gear is then again operated by the second electric motor. This time, the drive shafts of the ring gear and the drive shaft of the sun wheel of the planetary gear train rotate in a same direction.

An advantage of a method according to the present invention is the presence of sufficient propulsion energy before the vehicle starts to accelerate from standstill which energy can then be transmitted directly onto the axle drive unit without encountering any loss due to the provision of a clutch. As a consequence, smaller electric motors can be used which require less installation space and have less weight than electric motors for driving vehicles that lack a startup phase.

### BRIEF DESCRIPTION OF THE DRAWING

Other features and advantages of the present invention will be more readily apparent upon reading the following description of currently preferred exemplified embodiments of the invention with reference to the accompanying drawing, in which:

FIG. 1 is a schematic illustration of a drive according to the present invention in a startup phase;

FIG. 2 is a schematic illustration of the drive during acceleration from standstill;

FIG. 3 is a schematic illustration of the drive during travel;

FIG. 4 is a schematic illustration of the drive in an overdrive speed stage; and

FIG. 5 is a schematic illustration of the drive when backing up.

### DETAILED DESCRIPTION OF PREFERRED EMBODIMENTS

Throughout all the figures, same or corresponding elements may generally be indicated by same reference numerals. These depicted embodiments are to be understood as illustrative of the invention and not as limiting in any way. It should also be understood that the figures are not necessarily to scale and that the embodiments are sometimes illustrated by graphic symbols, phantom lines, diagrammatic representations and fragmentary views. In certain instances, details which are not necessary for an understanding of the present invention or which render other details difficult to perceive may have been omitted.

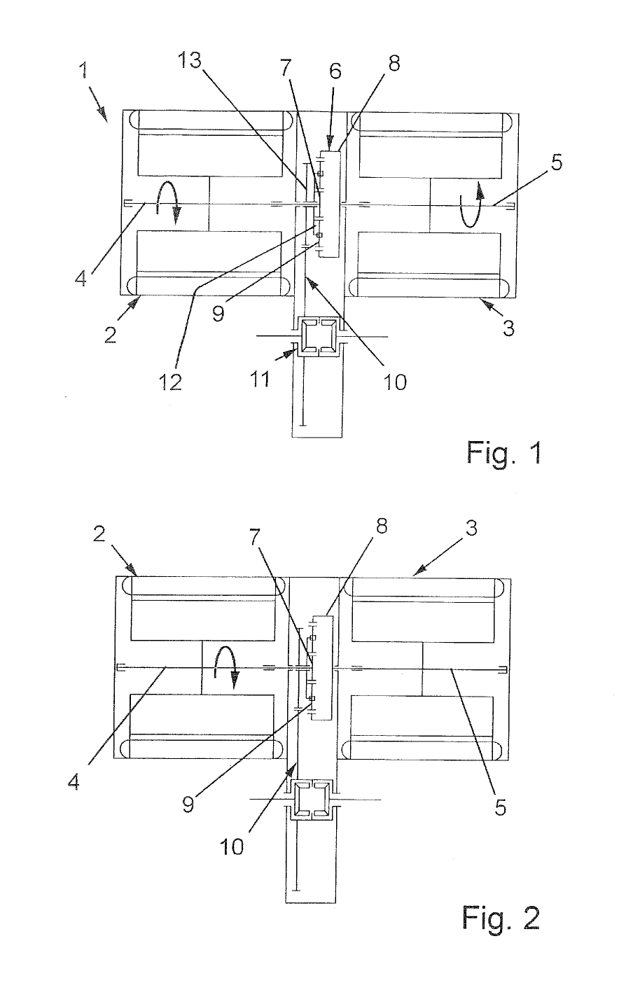

Turning now to the drawing, and in particular to FIG. 1, there is shown a schematic illustration of a drive according to the present invention, generally designated by reference numeral 1 for propelling a vehicle. The drive 1 includes a first electric motor 2 which is illustrated on a left-hand side of the drawing plane, and a second electric motor 3 which is illustrated on a right-hand side of the drawing plane. Drive shafts 4, 5 driven by the first and second electric motors 2, 3, respectively, are coupled to one another by a planetary gear train 6 illustrated in midsection of the drawing plane between the electric motors 2, 3. The drive shaft 4 driven by the first electric motor 2 is hereby connected with a sun wheel 7, and the drive shaft 5 driven by the second electric motor 2 is connected with a ring gear 8 of the planetary gear train 6. Arranged between the sun wheel 7 and the ring gear 8 are planet wheels 9 which engage with teeth of their outer toothed ring in an inner toothed ring of the ring gear 8 and an outer toothed ring of the sun wheel 7. The planet wheels 9 are supported by a planet carrier 12 which interacts with an axle drive unit 10 operably connected to wheels of the vehicle. The planet carrier 12 is connected with a gear 13 which, e.g., is engaged with the drive unit 10. The rotational movement of the planet carrier 12 is transmitted 1:1 onto the gear 13.

The axle drive unit 10 has a differential gear 11 for transmitting the rotational movement onto the wheel axle.

In a startup phase, the drive shaft 4 of the sun wheel 7 and the drive shaft 5 of the ring gear 8 rotate in opposite directions, as can be seen by the indicated arrows. The movement in opposite directions is caused by the confronting disposition of the output sides of the electric motors 2, 3. Viewed by itself, each electric motor 2, 3 rotates clockwise.

The rotation speeds of the drive shafts 4, 5 are matched to one another in such a manner that the planet wheels 9 of the planetary gear train 6 do not move around the sun wheel 7 so that there is no transmission of a rotational movement onto the axle drive unit 10 and thus onto the wheels of the vehicle.

As a result of the rotation speed reached in the startup phase, the electric motors 2, 3 operate in a beneficial characteristic mapping range so that an increased torque is present before the vehicle accelerates from standstill. This torque is transmitted during acceleration from standstill of the vehicle via the planet wheels 9 and the planet carrier 12 onto the axle drive unit 10 (FIG. 2). When the vehicle is ready to move, the rotation of the drive shaft 5 of the ring gear 8 is stopped. The planet wheels 9 begin to orbit around the sun wheel 7 and the rotation movement is transmitted from the planet carriers 12 via the axle drive unit 10 onto the wheels of the vehicle. As the sun wheel 7 rotates already before acceleration from standstill, a greater force can be transmitted onto the axle drive unit 10 as soon as acceleration begins compared to a situation in which a sun wheel were to begin to rotate at the moment of acceleration from standstill. Therefore, also heavier vehicles can now be propelled with electric motors when accelerating from standstill on uneven road surfaces.

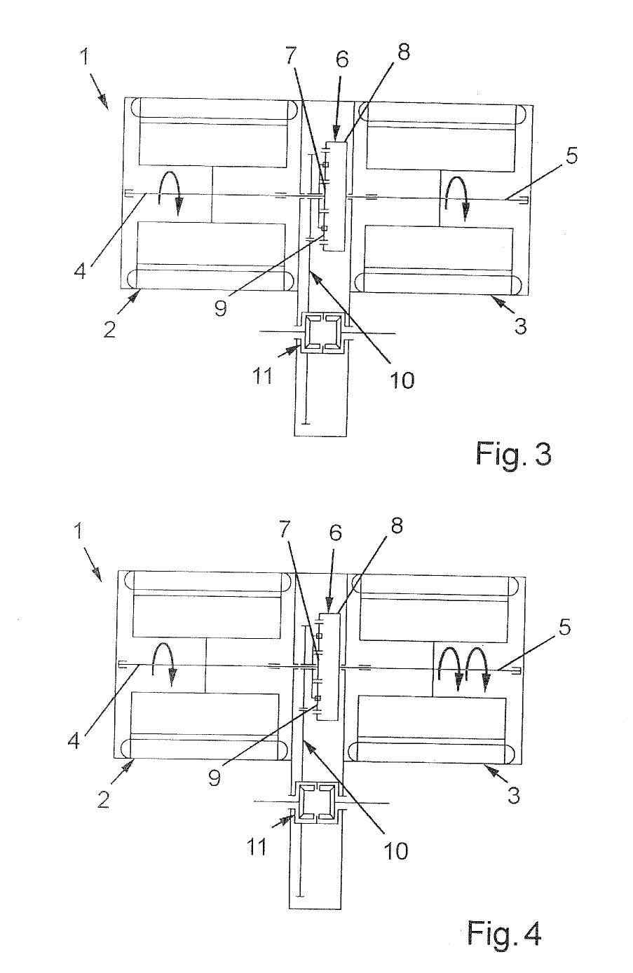

In order to generate more propulsion energy as the vehicle travels, the drive shaft 5 of the ring gear 8 is driven by the second electric motor 3 in a same direction as the drive shaft 4 of the sun wheel 7 (FIG. 3).

To reach the overdrive speed stage (FIG. 4), the drive shaft 5 that is coupled with the ring gear 8 is operated by the second electric motor 3 with twice the speed of the sun wheel 7 that is coupled with the first drive wheel 4 and operated by the first electric motor 2.

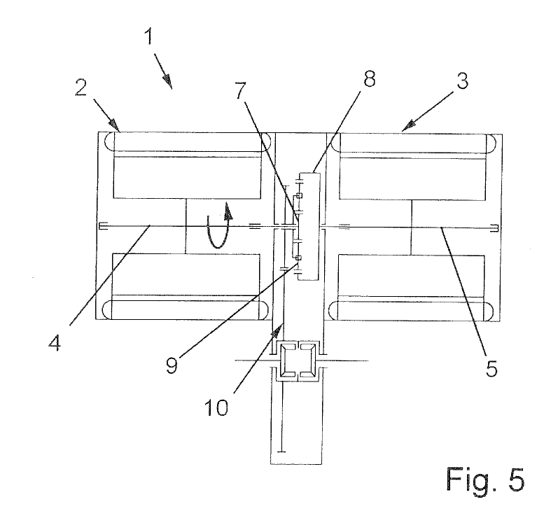

In order to allow a backup of the vehicle, the drive wheel 5 of the second electric motor 3 is switched-off and the drive shaft 4 coupled with the sun wheel 7 is rotated by the first electric motor 2 in an opposite direction (FIG. 5).

The invention completely eliminates the need for a clutch. By changing the relative rotation speed of both electric motors 2, 3, all desired travel conditions can be realized in a jerk-free manner similar to an automatic transmission while generating optimum torque. The drive is controlled by a (not shown) control unit which adjusts the rotation speeds and rotation directions of the electric motors depending on the desired speed.

While the invention has been illustrated and described in connection with currently preferred embodiments shown and described in detail, it is not intended to be limited to the details shown since various modifications and structural changes may be made without departing in any way from the spirit and scope of the present invention. The embodiments were chosen and described in order to explain the principles of the invention and practical application to thereby enable a person skilled in the art to best utilize the invention and various embodiments with various modifications as are suited to the particular use contemplated.

What is claimed as new and desired to be protected by Letters Patent is set forth in the appended claims and includes equivalents of the elements recited therein:

1. A drive for a vehicle, comprising:
a first electric motor;
a second electric motor;
a planetary gear train coupling the first and second electric motors, said planetary gear train including a sun wheel mounted on a drive shaft, and a ring gear mounted on a drive shaft; and
an axle drive unit operably connected with wheels of the vehicle and coupled with planet wheels of the planetary gear train,
wherein the drive shaft of the sun wheel is coupled with the first electric motor, and the drive shaft of the ring gear is coupled with the second electric motor, and
wherein the sun wheel and the ring gear are rotatable in opposite directions in a startup phase without propulsion of the wheels of the vehicle.

2. The drive of claim 1, wherein the drive shaft of the sun wheel and the drive shaft of the ring gear are rotatable at different speeds.

3. The drive of claim 1, wherein the axle drive unit includes a differential gear for transmitting a rotational movement onto an axle of the wheels of the vehicle.

4. The drive of claim 3, wherein the differential gear is an electric differential gear.

5. A method of propelling a vehicle, comprising the step of operating a drive shaft of a first electric motor and a drive shaft of a second electric motor in a startup phase of the vehicle such that a planet carrier of a planetary gear train is at a standstill so that there is no transmission of a driving force in the startup phase on a wheel axle coupled with the drive shafts via an axle drive unit.

6. The method of claim 5, wherein the drive shaft of the first electric motor is connected to a sun wheel of the planetary gear train and rotates as the vehicle begins to accelerate from standstill so that the planet carrier is caused to rotate while the drive shaft of the second electric motor is at a standstill and connected to a ring gear of the planetary gear train.

7. The method of claim 6, wherein the sun wheel and the ring gear are driven to rotate in a same direction by the electric motors during travel of the vehicle following the acceleration from standstill phase.

8. The method of claim 6, wherein the drive shaft for the ring gear rotates faster than the drive shaft for the sun wheel.

9. The method of claim 6, wherein the drive shaft for the ring gear rotates at twice the speed as the drive shaft for the sun wheel.
